(19) United States
(12) Patent Application Publication
(10) Pub. No.: US 2001/0021290 A1
(43) Pub. Date: Sep. 13, 2001

(54) Omnidirectional flex-type shape memory alloy film actuator individual, process for producing the same, and optical fiber

(76) Inventors: Akira Ishida, Ibaraki (JP); Morio Sato, Ibaraki (JP); Takahiro Sawaguchi, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 09/789,809

(22) Filed: Feb. 22, 2001

(30) Foreign Application Priority Data
Feb. 24, 2000 (JP) 048270/2000

(51) Int. Cl. G02B 6/35

(52) U.S. Cl. 385/22; 385/147

(57) ABSTRACT

The invention provides a shape memory alloy film actuator individual improved in mechanical reliability, miniaturized, and produced inexpensively, on a massive scale, and in a short time as compared with omnidirectional flex-type actuators in the related art depending upon the coils of a shape memory alloy. A shape memory alloy film is deposited on the outer periphery of a solid small-gage wire or a hollow capillary and integrated with the wire or the capillary, and then driving elements divided plurally are formed, thus to produce the shape memory alloy film actuator individual where omnidirectional flexing is possible.

### FIELD OF THE INVENTION

This invention relates to the structure of an omnidirectional flex-type shape memory alloy film actuator individual, a process for producing the same, and optical fiber. More specifically, it relates to the structure of a shape memory alloy film actuator individual of omnidirectional flex-type to the center of the axis wherein the structure of the individual can be simplified and miniaturized as compared with the structures of individuals in the related art by forming a shape memory alloy film on the outer periphery of a small-gage wire or a capillary and then wiring, and the production of the individual also can be simplified; a process for producing the same; and optical fiber.

### DESCRIPTION OF THE RELATED ART

Flex-type actuators where shape memory alloys are used have been hitherto proposed; for example, FIG. 6 shows a known actuator that can flex itself in the omnidirection. In this omnidirectional flex-type shape memory alloy actuator, the following mechanism is adopted; plural coils of a shape memory alloy stretched in the axial direction are set up on the periphery of a capillary, and heating of the individual coils allows the coils to shrink individually, thus the capillary moving in the omnidirection. Concretely, flanges B₁ and B₂ are fixed on both ends of flexible joint F and integrated, and three coils S₁, S₂, and S₃ exemplified are set up between flanges B₁ and B₂. In flexible joint F, the individual coils of a shape memory alloy are independently controlled in thermal shrinkage to control an angle of twist (φ), an angle of bending (θ), etc. between flanges B₁ and B₂; this makes omnidirectional flex possible.

It is thought that the omnidirectional flex-type shape memory alloy actuator in the related art having the aforesaid structure can be applied, for example, as a driving actuator of a flex mechanism in an active endoscope. This actuator for the endoscope having coil springs of a TiNi alloy and utilizing the characteristics of a shape memory effect depending upon R phase transformation is thought to present capability for active flexing over the entire length of an inserted endoscope such as a gastrocamera, to improve inserting or operating properties, and to mitigate pains of patients.

However, according to the results of practical examination of such structure proposed, the coils of a shape memory alloy inevitably occupy a large room; a limit is placed on the miniaturization of the entire actuator. In addition the concentration of stress is severe, and structural strength and durability to deformation stress attending upon driving cause problems.

Furthermore, in the omnidirectional flex-type shape memory alloy actuator proposed in the related art, fitting and adjustment of the coils of a shape memory alloy as well as the preparation of the coils from the shape memory alloy require a long time and much labor.

The invention, which has been done under these circumstances, aims at providing a novel means to an actuator utilizing the shape memory alloy of omnidirectional flex-type to the center of the axis wherein both structural strength and durability are satisfactory, the simplification and miniaturization of the structure are possible, and the simplification of the production of the actuators can be intended.

### SUMMARY OF THE INVENTION

For solving the aforesaid problems, first, the invention provides a shape memory alloy film actuator individual wherein as the structure of the omnidirectional flex-type shape memory alloy actuator individual, a shape memory alloy film formed by being divided plurally and integrated is set up on the outer periphery of a solid small-gage wire or a hollow capillary and simultaneously, a plurality of driving elements prepared by wiring the divided shape memory alloy films are set up, and the individual driving elements enable the omnidirectional flexing to the center of an axis. Secondly, the invention provides the omnidirectional flex-type shape memory alloy film actuator individual that is specified in constituent materials of the actuator individual wherein the solid small-gage wire or the hollow capillary is made of silica glass, and the shape memory alloy film is made of a TiNi alloy or that containing principally the alloy.

Thirdly, the invention provides a process for producing the shape memory alloy film actuator individual of omnidirectional flex type to the center of the axis comprising a step of forming a shape memory alloy film on the outer periphery of the solid small-gage wire or the hollow capillary, a step of cutting grooves on the film in the longer direction by cutting, abrasion, or etching to obtain divided shape memory alloy films, and a step of making a plurality of driving elements by wiring the divided shape memory alloy films. Fourthly, the invention provides a process for producing an articulated type shape memory alloy film actuator comprising a step of forming a plurality of films divided in the longer direction on the entire outer periphery of the solid small-gage wire or the capillary through masking or by use of masking shields or forming a plurality of films divided in the longer direction by etching after forming a film and a step of making a plurality of driving elements by cutting grooves on the divided shape memory alloy films and wiring thereof.

Furthermore, as application of the shape memory alloy film actuators, the invention provides, fifthly, optical fiber where any one of the aforesaid shape memory alloy film actuator individuals is set up, and sixthly, optical fiber actuated by multi-position switching where any one of the aforesaid shape memory alloy film actuator individuals is set up.

Marked miniaturization is possible simply by depositing the shape memory alloy film of several microns in thickness on the outer periphery of a capillary and integrating the shape memory alloy with the capillary.

Furthermore, according to the invention, from preparation to assembly of the shape memory alloy can be simply achieved by depositing the alloy while revolving the capillary. This enables great labor saving and cost cutting.

### DETAILED DESCRIPTION OF THE INVENTION

Embodiments of the invention having these features are illustrated below.

The actuator element individual of the first invention is the shape memory alloy film actuator element individual wherein basically the shape memory alloy film is deposited on the outer periphery of a solid small-gage wire or a hollow capillary to integrate the film with the small-gage wire or the capillary, subsequently the film is plurally marked off and divided, and driving elements are formed from the respective films divided, thus to enable the omnidirectional flex to the center of the axis.

A process for producing an omnidirectional flex-type shape memory alloy film actuator individual is shown as an example in FIG. 1.

(1) First, a shape memory alloy film is formed by sputtering on the outer periphery of a solid small-gage wire or a hollow capillary while revolving the wire or the capillary to integrate the film with the wire or the capillary. The solid small-gage wire or the hollow capillary is not necessarily pillar-like or cylindrical. The external shapes thereof can be polygonal (multilateral) or elliptic in section. However, the pillar or cylinder is preferred because of smooth omnidirectional flexing and good balance between durability and strength.

The shape memory alloy film set up on the outer periphery of the wire or the capillary and integrated therewith can be formed not only by sputtering but also by various vapor depositions such as ion beam and ion plating. In some cases, other means than the vapor deposition also can be adopted.

The film can be uniform or non-uniform over the entire outer periphery depending upon the purposes of actuators.

In the vapor deposition, the aforesaid small-gage wire or capillary can be revolved successively or intermittently. Or other methods than revolution can be adopted.

(2) Subsequently, the groove cutting such as cutting, abrasion, or etching is carried out, and needless portions are removed to cut grooves running in the axial direction (the longer direction), for example, as shown in FIG. 1. This groove cutting can be carried out by mechanical means such as cutting, and abrasion, by vapor-phase etching such as ion beam and plasma or by means of liquid etching agents. In these cases, it is as a matter of course that a means of masking can be suitably adopted.

(3) Subsequently, wiring is carried out, and areas divided plurally are produced from the film to form driving elements in the individual areas. About the shape memory alloy film actuator individual thus prepared, temperature control of the individual driving elements enables the omnidirectional flex to the center of the axis.

The wiring is carried out in order to control temperature of every region of the divided shape memory alloy films by sending an electric current. The wiring system or the means of wiring can be suitably adopted.

The control of an electric current enables flexing to the omnidirection (B, C, D, ) to the center of the axis (A) as shown in FIG. 1.

It is arbitrarily possible that the grooves are formed into spirals other than straight lines, and the width of the grooves is allowed to change, for example, in arithmetical series in place of a constant width.

In the actuator individuals as exemplified above, materials of the solid small-gage wire or the hollow capillary can be metals, alloys, ceramics, glass, plastics, and the composite materials of these including FRP.

The small-gage wire or the capillary in general is preferably made of materials that are good in thermal resistance and comparatively low in coefficient of thermal expansion and Young's modulus.

Shape memory alloys forming the film also include a variety of alloys such as Ni-Ti-Cu system, Ni-Ti-Pd system, and Cu-Al-Ni system alloys as well as Ni-Ti system alloys.

The film in general is subjected to a heat treatment at a temperature of 450° C. or higher to give bias force as a shape memory alloy. For example, in an example as described later, the heat treatment is carried out at a temperature of 550° C. for 1 hour. However, a similar degree of bias force can be given not only by the heat treatment, but also by residual stress generated in the film formed.

FIG. 2 shows another example of the invention. A plurality of omnidirectional flex-type shape memory alloy film actuator individuals as shown in FIG. 1 are prepared in the longer direction, forming an articulated type actuator that has a plurality of movable areas.

This actuator individual having plural movable areas can be produced, for example, according to the following steps.

(1) A shape memory alloy film is formed on the outer periphery of a solid small-gage wire or a hollow capillary while revolving the wire or the capillary and integrated with the wire or the capillary. In this case, by use of masking or masking shields on forming the film, films are partially formed on plural decided areas at intervals in the axial direction of the wire or the capillary except the areas undergoing masking. Or in the case where no masking is used, the shape memory alloy film is partially removed, for example, by etching after forming the film.

(2) Subsequently, the divided individual films are subjected to groove cutting and wiring according to the method as shown in FIG. 1. Thus, a plurality of omnidirectional flex-type shape memory alloy film actuator individuals are formed. The articulated type shape memory alloy film actuator having plural movable areas is produced by arranging a plurality of omnidirectional flex-type shape memory alloy films in the longer direction.

FIG. 3 shows application examples of the aforesaid omnidirectional flex-type shape memory alloy film actuator individuals. In FIG. 3, (a) shows an articulated manipulator holding an article, (b) shows an active catheter that can control the bending direction thereof at an inserted position, and (c) shows a light communication cable junction that can switch junction positions or an actuator for positioning of switching of optical fiber, respectively.

In addition to these examples, application to micro-bulbs or micro-pumps and application to light communication or medical micro-robots are expected. In consideration of free flexing of the fiber to the omnidirection, novel forms of micro-actuators have been expected in place of displacement-type actuators of bimorph structure used in micro-bulbs. The invention proposes the most basic structure of such a novel shape memory alloy film actuator individual and processes for producing the same.

The omnidirectional flex-type shape memory alloy film actuator individuals of this invention are illustrated in further detail below.

### EXAMPLES

FIG. 4 shows a section showing the constitution of an omnidirectional flex-type shape memory alloy film actuator individual of the invention composed of silica glass and a TiNi film corresponding to FIG. 1. FIG. 5 shows curvature radiuses attending on flexing of the shape memory alloy film actuator shown in FIG. 4 and maximum stresses acting on the film.

A study was carried out by use of silica glass as a solid small-gage wire and a TiNi alloy film as the shape memory alloy film with changing diameter D and thickness d of the respective materials. Bias force acting on the shape memory alloy film is designed to give by thermal strain generated by the temperature difference (ΔT) when actuators are cooled from a temperature of the heat treatment (550° C.) to room temperature (25° C.) . Concretely, the heat treatment was carried out at a temperature of 550° C. for 1 hour. The TiNi film forms a martensite phase at room temperature, and the form follows easily the form of silica glass by rearrangement of a variant. Herein, when only the upper TiNi layer is heated over a inverse transformation temperature (about 70° C.), the upper TiNi layer is inversely transformed to the parent phase to insist the form intrinsic to the TiNi film. That is, a stress stemming from thermal strain acts between the silica glass and the TiNi layer.

From a conditional equation satisfying the balance between forces in the direction of fiber and the balance between forces of rotational moment, the curvature radius R of a warp of silica glass in this condition was given by the following equation, when the elastic constant, Poisson's ratio, and thermal expansion coefficient of the TiNi film and silica glass were Ef, νf, and αf and Es, νs, and αs, and t=d/D, e=Ef(1−νs)/Es (1−νf):

R=D(1+4et³+4et+6et²+e²t⁴) /6(αf−αs)ΔT(et²+et)

The maximum tensile stress S to the shape memory alloy film, which acts at the interface of silica glass, was determined by the following equation in consideration of mechanics of materials:

S={Ef(αf−αs)ΔT/(et+1)}+{(t−(ed²+D²+2Dd)/2(ed+D))/R}

FIG. 5 shows how the curvature of silica glass and the maximum stress acting on the shape memory alloy film change according to change in thickness (d) of the film and diameter (D) of the wire. FIG. 5 reveals that the curvature radius (R) of silica glass changes from 1 mm to 50 mm to acquire flex sufficient for practical use. In addition, the maximum stress acting on the film was found to fall in the range of 400 MPa to 800 MPa where the film exercises practically sufficient capability thereof. (Similar stress can be loaded by residual stress on forming the film.)

As described above in detail, the invention can markedly miniaturize omnidirectional flex-type actuators (for example, 1/1000) as compared with actuators where shape memory alloy films in the related art are used.

As a result, the preparation of active type micro-catheters, articulated micromanipulators, and cable junctions or positioning mechanisms of optical fiber becomes possible.

In the omnidirectional flex-type shape memory alloy actuators in the related art, force is focused on a supporting point of the coils of an alloy. On the other hand, in the shape memory alloy film actuator individuals of the invention, the film is integrated with a small-gage wire, and force uniformly acts on a curved portion. This leads to improvement in mechanical reliability of the wire.

Furthermore, according to the invention, the individuals can be efficiently produced inexpensively, on a massive scale, and in a short time as compared with the omnidirectional flex-type actuators in the related art.

### BRIEF DESCRIPTION OF THE DRAWINGS

FIG. 1 is a drawing showing an example of the preparation and structure of an omnidirectional flex-type shape memory alloy film actuator individual;

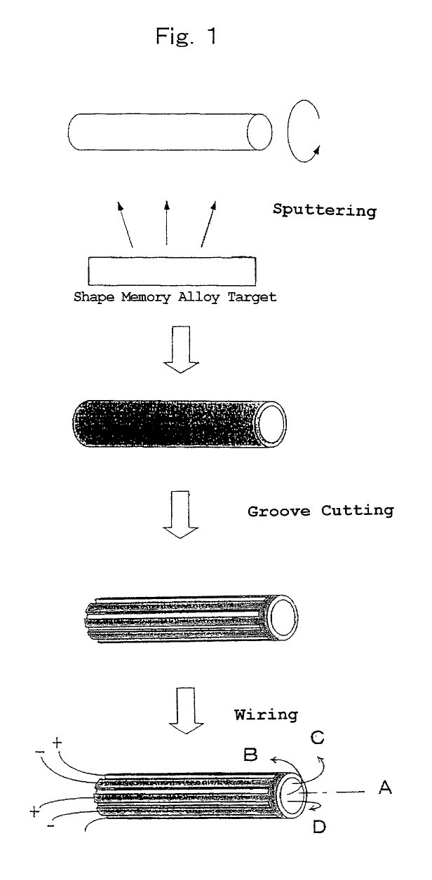

FIG. 2 is a drawing showing an example of steps for producing an articulated shape memory alloy film actuator individual;

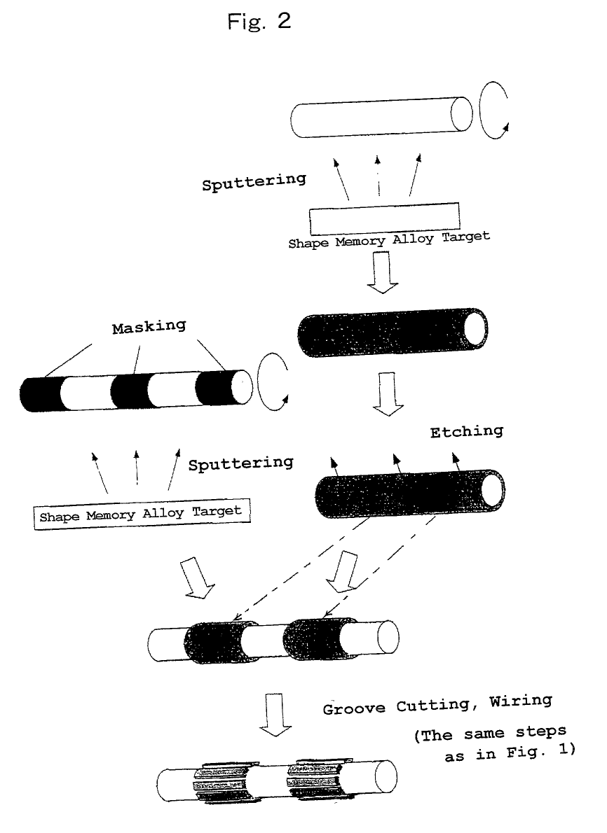

FIG. 3 is a drawing showing application examples of an omnidirectional flex-type shape memory alloy film actuator individual;

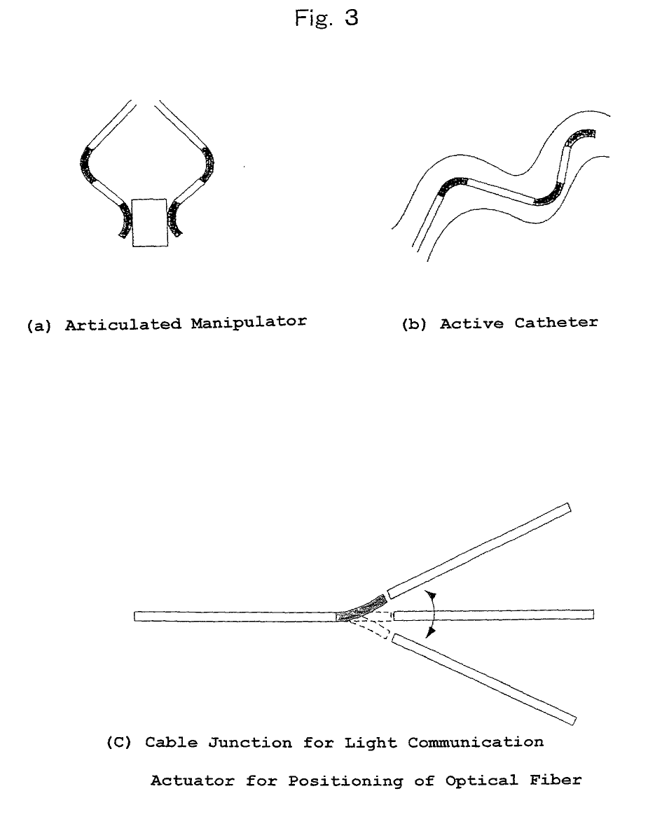

FIG. 4 is a drawing showing an example of the constitution of an omnidirectional flex-type shape memory alloy actuator constituted of silica glass and a TiNi film;

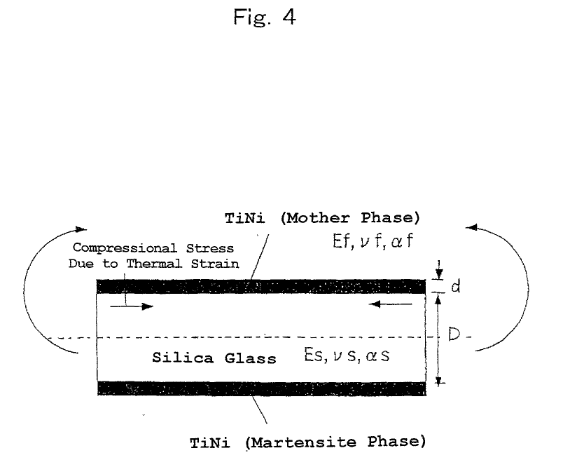

FIG. 5 is diagrams showing the curvature radius of a warp of the silica glass and the maximum stress acting on the shape memory alloy film obtained from the shape memory alloy film actuator individual shown in FIG. 4; and

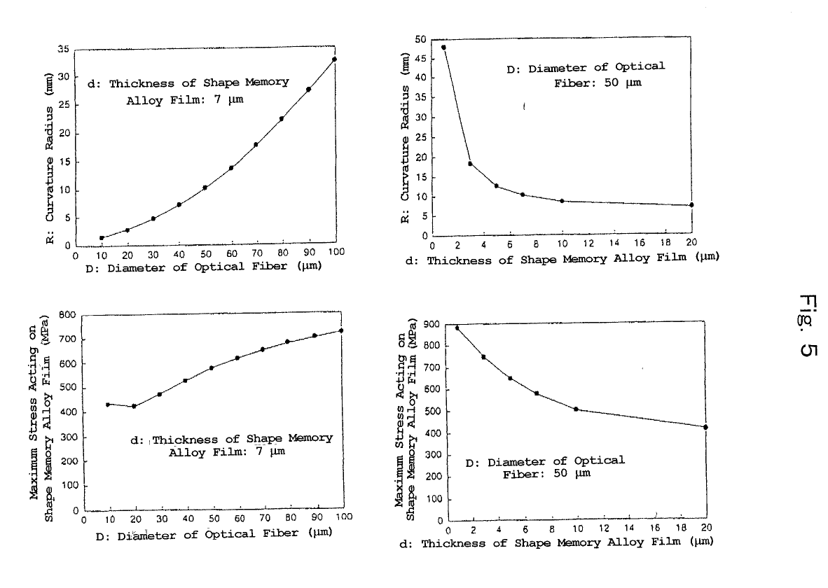

FIG. 6 is a drawing showing an omnidirectional flex-type shape memory alloy film actuator in the related art.

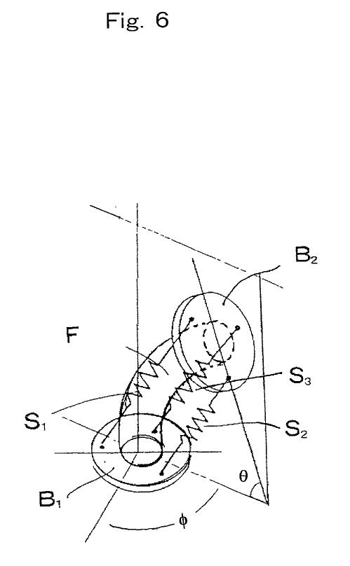

What is claimed is:

1. An omnidirectional flex-type shape memory alloy film actuator individual wherein shape memory alloy films formed by dividing plurally and integrated are set up on an outer periphery of a solid small-gage wire or a hollow capillary and simultaneously, a plurality of driving elements where the divided films are wired are set up, and the individual driving elements enable omnidirectional flex to a center of an axis.

2. An individual according to claim 1 wherein the solid small-gage wire or the hollow capillary is of silica glass, and the shape memory alloy film formed on the outer periphery of the wire or the capillary and integrated is a TiNi alloy or that containing principally the same.

3. A process for producing a shape memory alloy film actuator individual of omnidirectional flex-type to the center of the axis, process which comprises a step of forming a shape memory alloy film on the outer periphery of a solid small-gage wire or a hollow capillary, a step of cutting grooves on the formed film in the longer direction by cutting, abrasion, or etching to obtain divided shape memory alloy films, and a step of wiring the divided films to make a plurality of driving elements.

4. A process for producing an articulated type shape memory alloy film actuator, process which comprises a step of forming a plurality of films divided in the longer direction on the outer periphery of a solid small-gage wire or a hollow capillary through masking or a masking shield or forming a plurality of films divided in the longer direction by etching and a step of cutting grooves on the divided films and wiring the films to make a plurality of driving elements.

5. Optical fiber where the shape memory alloy film actuator individual of claims 1 or 2 is set up.

6. Optical fiber according to claim 5 which is actuated for multi-position switching.
